(19) United States
(12) Patent Application Publication
(10) Pub. No.: US 2022/0138639 A1
(43) Pub. Date: May 5, 2022

(54) INVENTORY MANAGEMENT SYSTEM FOR RENTAL SPACE

(71) Applicant: TAISHO SKY BUILDING, INC., Tokyo (JP)

(72) Inventor: Kazuharu ISHIDA, Tokyo (JP)

(21) Appl. No.: 17/578,438

(22) Filed: Jan. 18, 2022

Related U.S. Application Data
(63) Continuation of application No. PCT/JP2019/028311, filed on Jul. 18, 2019.

(51) Int. Cl. G06Q 10/02; G06Q 10/08

(52) U.S. Cl. CPC G06Q 10/02; G06Q 10/087

(57) ABSTRACT

A rental space inventory management system includes: a host which is a management device connected to a communication line; a terminal device which is a user input unit that is connected to the host via the communication line and receives information input from a user; and an inventory management unit that manages an inventory of goods provided to the user who uses a space. A control unit of the host includes: a reservation manager that manages reservation information of a room which is received from the terminal device of the user; a goods information obtainer that obtains goods information on the inventory of the goods in the room from the inventory management unit; and a goods billing part that charges a consideration according to the variation of the inventory of the goods to the user on the basis of the reservation information and the goods information.

### RELATED APPLICATIONS

The present application is a continuation of International Patent Application No. PCT/JP2019/028311, filed Jul. 18, 2019, which is hereby incorporated by reference in its entirety.

### TECHNICAL FIELD

This disclosure relates to a rental space inventory management system that sets a usage time and rents a space to a user.

### BACKGROUND

A system for renting rooms of a building (e.g., an office, a hotel, or the like) to users typically includes a management server open to a communication network such as the Internet, and a plurality of reservation servers in which information on the conference room is stored (see, e.g., Japanese patent JP-A-2002-150178). Such a system is typically configured so that users can access information describing the conference room in a reservation server via the management server and reserve a desired conference room. Such a system also typically has a billing function so that a rental fee can be paid online.

Further, a conventional rental conference room support system may charge an appropriate amount of money according to a usage mode for use of a content output device used for a conference (see, e.g., Japanese patent JP-A-2017-174391). Such a system may include a content storage unit that stores content transmitted from a terminal of the user, a content output control unit that receives an output request from the terminal of the user and transmits the content to the output device to output the content, and a billing calculation unit that calculates a usage fee of the output device according to an output mode of the content, calculates the usage fee according to a usage status of equipment such as an electronic blackboard or a projector, which is the content output device, and charges the usage fee.

### SUMMARY

In some reservation systems, it may be possible to reserve use of a rental space (e.g., a conference room), calculate a usage fee according to the usage status of equipment used in the space, and charge the usage fee. However, it may not be possible to deal with a case where the equipment used by the user in the space is a consumable item. In other words, it may be difficult to determine an amount of usage of the consumable item. In such systems, an administrator or the like may be required to check the amount of usage, which requires manpower, and calculate the usage fee after checking the amount of usage. This takes time for processing billing information, thereby reducing the operational efficiency of such systems. An object of the present disclosure is to provide a rental space inventory management system that improves the operational efficiency of reservation systems by reducing labor costs and processing time.

The rental space inventory management system in some implementations is a rental space inventory management system that sets a usage time and rents a space to a user, including: a management device that is connected to a communication line to manage information; a user input unit that is connected to the management device via the communication line and receives information input from the user to the management device; and an inventory management unit that is connected to the management device via the communication line and manages an inventory of goods provided to the user who uses the space, in which the management device includes: a reservation manager that manages reservation information on the user who uses the space received via the user input unit, and on reservation date and time; a goods information obtainer that obtains goods information on variation of the inventory of the goods from the inventory management unit; and a goods billing part that charges a consideration according to the variation of the inventory of the goods to the user who uses the space on the basis of the reservation information and the goods information.

According to the implementations as described above, the management device includes: a reservation manager that manages reservation information on the user who uses the space received via the user input unit, and on the reservation date and time; the goods information obtainer that obtains the goods information on the variation of the inventory of the goods from the inventory management unit; and the goods billing part that charges the consideration according to the variation of the inventory of the goods to the user who uses the space on the basis of the reservation information and the goods information, so that it is possible to immediately grasp the variation of the inventory of the goods (that is, the amount of usage of the goods used by the user) and charge the consideration (usage fee) according to the amount of usage of the goods. Therefore, it is not necessary to manually check the amount of usage of the goods and to charge the usage fee after checking the amount of usage, so that the operation efficiency of the system can be improved by reducing the labor costs and the processing time. Further, the goods information obtainer can grasp an amount of stock of the goods by obtaining the goods information on the variation of the inventory of the goods from the inventory management unit, so that it is possible to prepare for ordering and replenishment when the inventory is reduced, thereby avoiding a situation in which the goods are out of stock and cannot be used by the user.

In some implementations, the management device includes: an inventory information obtainer that obtains inventory information on a current goods inventory from the inventory management unit, when receiving the information input to the management device by the user input unit; and an inventory information discloser that discloses the inventory information obtained by the inventory information obtainer to the user.

According to such a configuration, when the management device receives the information input from the user input unit, the management device discloses the inventory information on the current goods inventory to the user, so that the user can check the current goods inventory, and can place an order to increase the inventory of the goods according to an inventory status of the goods.

Further, in some implementations, the management device includes: an inventory information obtainer that obtains inventory information on a current goods inventory from the inventory management unit, when receiving the information input to the management device by the user input unit; a prediction information calculator that calculates prediction information predicting the inventory of the goods at the reservation date and time when using the space received via the user input unit on the basis of the inventory information obtained by the inventory information obtainer; and a prediction information discloser that discloses the prediction information calculated by the prediction information calculator to the user.

According to such a configuration, when receiving the information input from the user input unit, the management device predicts the inventory of the goods on the basis of the inventory information on the current goods inventory and discloses the prediction information to the user, so that the user can check the inventory of the goods at the reservation date and time when the space is used, and can place the order to increase the inventory of the goods according to the inventory status.

Furthermore, in some implementations, the rental space inventory management system includes a shared inventory management unit that is disposed in a shared space provided side by side with a plurality of spaces and manages an inventory of shared goods provided to the user, the management device includes: an identification code manager that manages identification code information related to identification codes individually set for the spaces; a shared goods information obtainer that obtains shared goods information on the variation of the inventory of the shared goods from the shared inventory management unit; and a shared goods billing part that charges the consideration according to the variation of the inventory of the shared goods to the user who uses the space on the basis of the reservation information, the identification code information, and the shared goods information, and the shared inventory management unit switches between an available state in which the shared goods are available to the user when the identification code is received and an unavailable state in which the shared goods are unavailable to the user when the identification code is not received.

According to such a configuration, the management device includes: the identification code manager that manages the identification code information related to the identification codes individually set for the spaces; the shared goods information obtainer that obtains the shared goods information on the variation of the inventory of the shared goods from the shared inventory management unit; and the shared goods billing part that charges the consideration according to the variation of the inventory of the shared goods to the user who uses the space on the basis of the reservation information, the identification code information, and the shared goods information, so that it is possible to charge the consideration for the shared goods to the user who has been given the identification code according to the variation of the inventory of the shared goods. Further, the shared inventory management unit switches between the available state in which the shared goods are available to the user when the identification code is received and the unavailable state in which the shared goods are unavailable to the user when the identification code is not received, so that only the user who has been given the identification code can use the shared goods, thereby preventing unauthorized use of the shared goods by another user or the like.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of a rental space in accordance with some implementations.

FIG. 2 is a block diagram illustrating a configuration of a management device for the rental space.

FIG. 3 is a flowchart illustrating an operation of the management device for the rental space.

FIG. 4 is a flowchart illustrating another operation of the management device for the rental space.

### DETAILED DESCRIPTION

Hereinafter, implementations will be described with reference to the drawings.

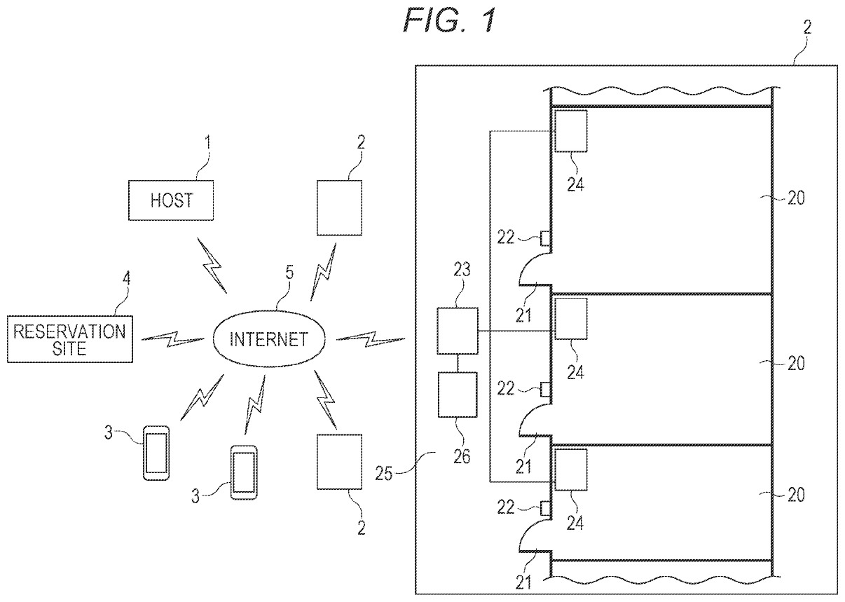

FIG. 1 is a schematic configuration diagram of a rental space in accordance with some implementations.

As illustrated in FIG. 1, the rental space includes a host 1 which is a management device for managing the rental space, and a plurality of rooms 20, each of which is a space for renting to users, and there is a plurality of buildings 2 having the plurality of rooms 20. The host 1, the buildings 2, terminal devices 3 (e.g., a mobile phone, a smart phone, or a personal computer owned by a user), and a reservation site 4 for reserving a rental of the room 20 can be connected to each other via the Internet 5 which is a public network as a communication line. The user can access the reservation site 4 via the Internet 5 using a terminal device 3 as a user input unit, search for the room 20 according to a purpose, and specify a usage time and the number of users, to perform a reservation. When the reservation site 4 receives the reservation from the user, the reservation site 4 transmits and receives various information to and from the host 1, and transmits reservation information related to the room 20 for which the reservation has been established to the terminal device 3.

The building 2 includes rooms 20 (e.g., a conference room or a training room), and each room 20 is provided with a doorway 21 and a locking device 22 for locking and unlocking the doorway 21. The locking device 22 can be unlocked by an authentication key that is an identification code such as a password or a bar code issued from the reservation site 4 to the terminal device 3 of the user, and the authentication key is randomly changed each time it is used, so that only the user who made a reservation at that time can unlock the locking device 22 by using a unique authentication key. A communication terminal device 23 such as a modem or a router is connected to each room 20 via a local area network (LAN), and the communication terminal device 23 is connected to the host 1 via the Internet 5. Note that in some implementations, the password, the bar code, or the like is employed as the authentication key, however, for example, biometric authentication such as face authentication, fingerprint authentication, or retinal authentication may be employed, and any authentication key may be used as long as it can unlock the locking device 22.

Each room 20 is provided with an inventory management unit 24 that manages an inventory of goods which are consumables provided to users who use the room 20. The inventory management unit 24 manages, for example, an amount of stock of drinks (the goods) in a drink server provided in the room 20, manages the amount of stock of printing paper and toner in a copier and a printer, and manages the amount of stock of stationery and the like in a vending machine for stationery and storage media. The inventory management unit 24 is connected to the host 1 via the communication terminal device 23. Further, the building 2 is provided with a shared space 25 (e.g., a lobby, a meeting space, a resting space, and/or a restroom), which is outside each room 20 and can be shared by a plurality of users. The shared space 25 is provided with a shared inventory management unit 26 that manages the inventory of shared goods which are the consumables provided to users. The shared inventory management unit 26 manages the amount of stock of the drinks and food (goods) in the vending machine provided in the shared space 25, manages the amount of stock of the printing paper and toner in the copier, the printer, and facsimile, manages the amount of stock of stationery and the like in the vending machine for stationery and storage media, and manages the amount of stock of toilet paper in the restroom. The shared inventory management unit 26 is connected to the host 1 via the communication terminal device 23. Such an inventory management unit 24 and a shared inventory management unit 26 are provided with various sensors (for example, a weight sensor, a position sensor, a pressure sensor, or the like) for detecting the amount of stock of the goods and the shared goods. This sensor is configured as a device that can transmit a measured value to the host 1 via the communication terminal device 23 and the Internet 5 and of which operation can be controlled from the host 1, that is, a so-called Internet of Things (IoT) device.

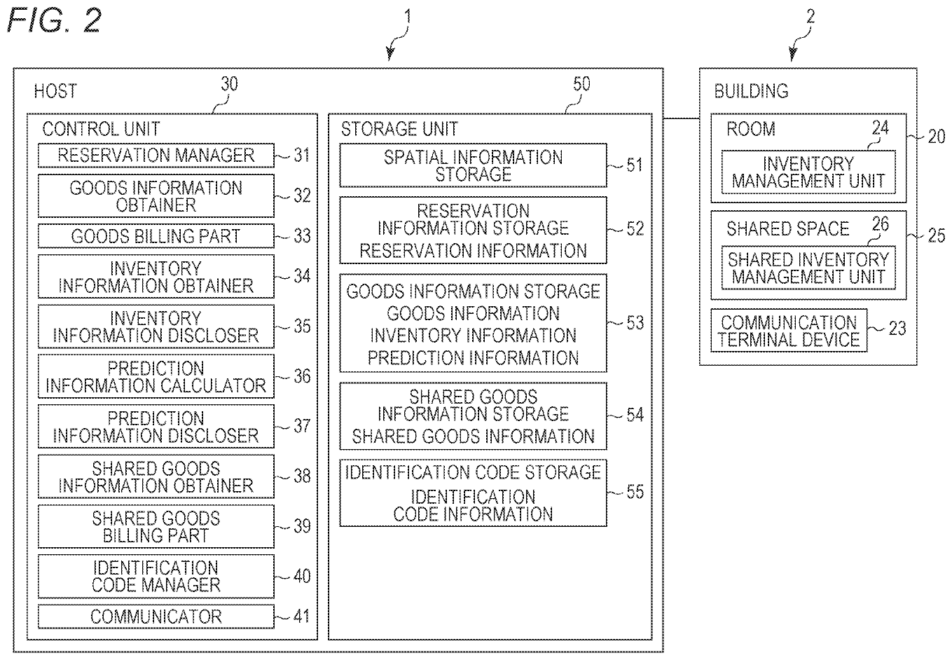

FIG. 2 is a block diagram illustrating a configuration of the management device for the rental space. The host 1, which is the management device for the rental space, includes a server device, and as illustrated in FIG. 2, includes a control unit 30 including a central processing unit (CPU) or the like, and a storage unit 50 including a storage device such as a hard disk drive (HDD). The control unit 30 includes a reservation manager 31 that manages the reservation information reserved by the user via the reservation site 4, a goods information obtainer 32 that obtains goods information on variation of the inventory of the goods (an amount by which the inventory of the goods has changed) from the inventory management unit 24, and a goods billing part 33 that charges a consideration according to the variation of the inventory of the goods to the user who uses the room 20 on the basis of the reservation information and the goods information. Further, the control unit 30 includes an inventory information obtainer 34 that obtains inventory information on a current goods inventory in each room 20 from the inventory management unit 24, when receiving the reservation from the terminal device 3 of the user to the host 1 via the reservation site 4, and an inventory information discloser 35 that discloses the inventory information obtained by the inventory information obtainer 34 to the terminal device 3 of the user. Furthermore, the control unit 30 includes a prediction information calculator 36 that calculates prediction information predicting the inventory of the goods at the reservation date and time when using the room 20 that received the reservation on the basis of the inventory information obtained by the inventory information obtainer 34, when receiving the reservation from the terminal device 3 of the user to the host 1 via the reservation site 4, and a prediction information discloser 37 that discloses the prediction information calculated by the prediction information calculator 36 to the terminal device 3 of the user.

The storage unit 50 includes: a spatial information storage 51 that stores information of all the rooms 20 to be managed; a reservation information storage 52 that stores the reservation information including the reservation date and time when the room 20 is used and the number of users; and a goods information storage 53 that stores the goods information and the inventory information obtained from the inventory management unit 24 with respect to the goods provided in the room 20, and the prediction information predicted by the prediction information calculator 36. When the reservation manager 31 receives the reservation from the user, the control unit 30 causes the reservation information storage 52 to store the reservation information on the basis of the reservation information and the information of all the rooms 20 stored in the spatial information storage 51. Further, the control unit 30 causes the goods information storage 53 to store the goods information and the inventory information obtained from the inventory management unit 24 with respect to the goods in the reserved room 20, causes the prediction information calculator 36 to predict the inventory of the goods at the reservation date and time, and causes the goods information storage 53 to store the calculated prediction information. Furthermore, after the room 20 has been used, the control unit 30 causes the goods information obtainer 32 to obtain the goods information on the variation of the inventory of the goods, and the goods billing part 33 charges the user for the consideration according to the variation of the inventory of the goods on the basis of the reservation information and the goods information.

The control unit 30 includes a shared goods information obtainer 38 that obtains shared goods information on the variation of the inventory of the shared goods provided in the shared space 25 from the shared inventory management unit 26, and a shared goods billing part 39 that charges the consideration according to the variation of the inventory of the shared goods to the user who uses the room 20. Further, the control unit 30 includes an identification code manager 40 that manages identification code information related to authentication keys (identification codes) individually set for the rooms 20, and a communicator 41 that controls communication with the communication terminal device 23, the reservation site 4, and the terminal device 3 of the user. The storage unit 50 includes a shared goods information storage 54 that stores the shared goods information obtained from the shared inventory management unit 26 with respect to the shared goods provided in the shared space 25, and an identification code storage 55 that stores the identification code information related to the authentication key set by the identification code manager 40. The shared inventory management unit 26 switches between an available state in which the shared goods are available to the user when the authentication key is received and an unavailable state in which the shared goods are unavailable to the user when the authentication key is not received. After the room 20 has been used, the control unit 30 causes the shared goods information obtainer 38 to obtain the shared goods information on the variation of the inventory of the shared goods, and the shared goods billing part 39 charges the user for the consideration according to the variation of the inventory of the shared goods on the basis of the reservation information, the identification code information, and the shared goods information.

Note that the reservation manager 31, the goods information obtainer 32, the goods billing part 33, the inventory information obtainer 34, the inventory information discloser 35, the prediction information calculator 36, the prediction information discloser 37, the shared goods information obtainer 38, the shared goods billing part 39, the identification code manager 40, and the communicator 41 may be executed as a program by the CPU of the server device, may be configured by independent devices, or may be configured using cloud computing. Further, the storage unit 50 may be configured by the storage device such as the HDD, or may use a storage unit of a cloud service. Further, the terminal device 3 that functions as the user input unit may be a device such as a smartphone including an input unit that receives input from the user, a display for notifying the user of information, a communicator for transmitting and receiving information to and from the host 1, and a controller that controls the input unit, the display, the communicator, and the like, or may be a device in which the input unit, the display, the communicator, and the controller are configured by independent devices.

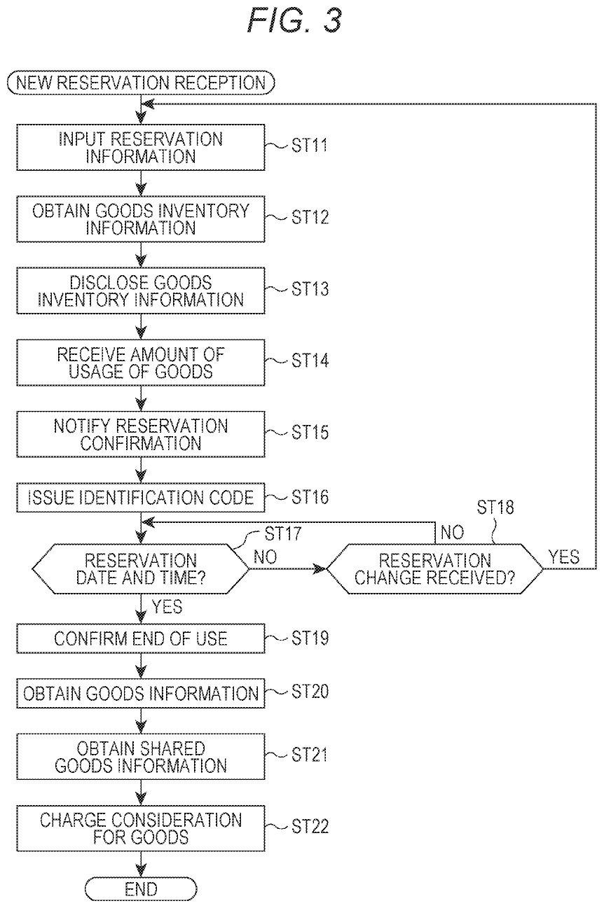

FIG. 3 is a flowchart illustrating an operation of the management device for the rental space.

The flowchart of FIG. 3 illustrates an operation procedure of the host 1 after receiving a new reservation by the user. When the reservation manager 31 receives the reservation from the reservation site 4, the control unit 30 of the host 1 allocates the room 20 on the basis of the information of all the rooms 20 stored in the spatial information storage 51, and causes the reservation information storage 52 to store the reservation information (Step ST11). Subsequently, the control unit 30 causes the inventory information obtainer 34 to obtain the inventory information on the current goods inventory for the allocated room 20 from the inventory management unit 24 (goods inventory information obtaining step: Step ST12). Subsequently, the control unit 30 causes the inventory information discloser 35 to disclose the goods inventory information obtained by the inventory information obtainer 34 to the user (goods inventory information disclosure step: Step ST13).

Subsequently, the reservation manager 31 of the control unit 30 receives a request for an amount of usage of the goods on a date of use from the terminal device 3 of the user (Step ST14), and if the inventory is likely to be insufficient on the basis of the requested amount of usage and the inventory information, an administrator is notified that replenishment is necessary. When reception of the reservation is completed, the reservation manager 31 generates a notification command of reservation confirmation and transmits it to the terminal device 3 of the user (Step ST15). Further, the control unit 30 causes the identification code manager 40 to issue the authentication key that can be used at a date and time of use for the allocated room 20, causes the identification code storage 55 to store the identification code information related to the authentication key, and transmits the authentication key to the terminal device 3 of the user (identification code issuing step: Step ST16). Furthermore, the identification code manager 40 transmits the identification code information to the locking device 22 of the allocated room 20 of the building 2 and the shared inventory management unit 26 of the shared space 25, to enable the locking device 22 to be unlocked by using the authentication key at the date and time of use, and puts the shared goods in the available state in which the shared goods are available to the user by using the authentication key by the shared inventory management unit 26. On the other hand, the shared inventory management unit 26 is in the unavailable state in which the shared goods are unavailable to the user when the identification code is not received.

Subsequently, the control unit 30 is in a standby state of waiting for reception of reservation change until a predetermined time before the reservation date and time (for example, the day before the reservation date). That is, time is measured until the reservation date and time is reached (Step ST17), and if it is before the reservation date and time (NO in Step ST17), the reservation manager 31 checks whether the reservation change is input from the reservation site 4 (Step ST18). When the reservation manager 31 receives the reservation change from the reservation site 4 (YES in Step ST18), the above-mentioned Steps ST11 to ST16 are executed. On the other hand, when the reservation change is not received (NO in Step ST18), the control unit 30 returns to Step ST17 and maintains the standby state of the reception of the reservation change. If the reservation cannot be changed after the predetermined time before the reservation date and time has passed (YES in Step ST17), the control unit 30 monitors a usage status of the allocated room 20 at the date and time of use.

Subsequently, when an end of use of the allocated room 20 is confirmed after the date and time of use has passed (Step ST19), the control unit 30 causes the goods information obtainer 32 to obtain the goods information on the variation of the inventory of the goods in the room 20 from the management unit 24 (goods information obtaining step: Step ST20). Further, the control unit 30 causes the shared goods information obtainer 38 to obtain the shared goods information on the variation of the inventory of the shared goods in the shared space 25 from the shared inventory management unit 26 (shared goods information obtaining step: Step ST21). Subsequently, the control unit 30 charges the consideration according to the variation of the inventory of the goods by the goods billing part 33 on the basis of the reservation information and the goods information, and charges the consideration according to the variation of the inventory of the shared goods by the shared goods billing part 39 on the basis of the reservation information, the identification code information of the authentication key, and the shared goods information (goods consideration billing step: Step ST22).

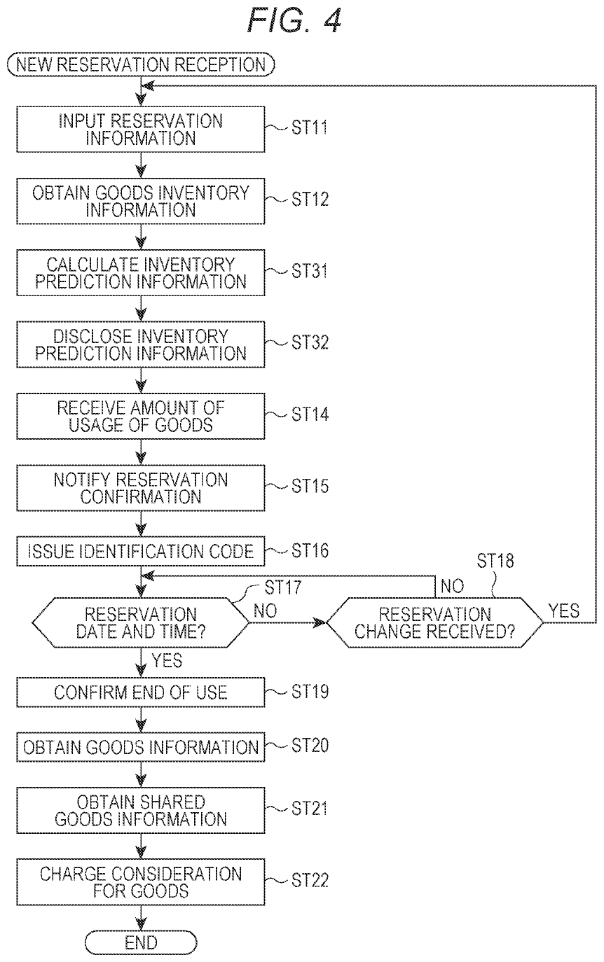

FIG. 4 is a flowchart illustrating another operation of the management device for the rental space.

In the flowchart illustrated in FIG. 4, the operation of the host 1 is different from the case of FIG. 3 in that the following Steps 31 and 32 are executed instead of the goods inventory information disclosure step (Step ST13) in the flowchart of FIG. 3, and other operations are the same as in the case of FIG. 3. That is, when the inventory information obtainer 34 obtains the inventory information on the current goods inventory for the allocated room 20 in Step ST12, the control unit 30 causes the prediction information calculator 36 to calculate the prediction information predicting the inventory of the goods at the reservation date and time when using the room 20 on the basis of the inventory information (inventory prediction information calculation step: Step ST31). Here, the prediction information calculator 36 calculates inventory prediction information on the basis of a past usage status of the goods, other reservation status of the room 20 up to the reservation date and time, or the like. Subsequently, the control unit 30 causes the prediction information discloser 37 to disclose the prediction information calculated by the prediction information calculator 36 to the user (inventory prediction information disclosure step: Step ST32).

According to the implementations as described above, the following operations and effects can be obtained.

(1) The control unit 30 of the host 1 includes: the reservation manager 31 that manages the reservation information of the room 20 which is received from the terminal device 3 of the user; the goods information obtainer 32 that obtains, from the inventory management unit 24, the goods information on the variation of the inventory of the goods in the room 20; and the goods billing part 33 that charges the consideration according to the variation of the inventory of the goods to the user who uses the room 20 on the basis of the reservation information and the goods information, so that it is possible to immediately grasp the amount of usage of the goods used by the user, and charge the consideration according to the amount of usage of the goods. Therefore, it is not necessary to manually check the amount of usage of the goods and to charge the usage fee after checking the amount of usage, so that the operation efficiency of the system can be improved by reducing the labor costs and the processing time. Further, the goods information obtainer 32 can grasp the amount of stock of the goods by obtaining the goods information on the variation of the inventory of the goods from the inventory management unit 24, so that it is possible to prepare for ordering and replenishment when the inventory is reduced, thereby avoiding a situation in which the goods are out of stock and cannot be used by the user.

(2) When the control unit 30 of the host 1 receives information input from the terminal device 3 of the user, the control unit 30 discloses the inventory information on the current goods inventory to the user by the inventory information discloser 35, so that the user can check the current goods inventory, and can place an order to increase the inventory of the goods according to an inventory status of the goods.

(3) When the control unit 30 of the host 1 receives information input from the terminal device 3 of the user, the control unit 30 calculates the inventory of the goods at the reservation date and time when the room 20 is used, by the prediction information calculator 36 on the basis of the inventory information on the current goods inventory, and discloses the prediction information predicting the inventory to the user by the prediction information discloser 37, so that the user can check the inventory of the goods at the reservation date and time when the room 20 is used, and can place the order to increase the inventory of the goods according to the inventory status of the goods.

(4) The control unit 30 of the host 1 includes the identification code manager 40 that manages the identification code information related to the authentication keys (identification codes) individually set for the rooms 20, the shared goods information obtainer 38 that obtains the shared goods information on the variation of the inventory of the shared goods in the shared space 25 from the shared inventory management unit 26, and the shared goods billing part 39 that charges the consideration according to the variation of the inventory of the shared goods to the user who uses the room 20 on the basis of the reservation information, the identification code information, and the shared goods information, so that it is possible to charge the consideration for the shared goods to the user who has given the authentication key according to the variation of the inventory of the shared goods. Further, the shared inventory management unit 26 switches between the available state in which the shared goods are available to the user when the identification code is received and the unavailable state in which the shared goods are unavailable to the user when the identification code is not received, so that only the user who has been given the authentication key can use the shared goods, thereby preventing unauthorized use of the shared goods by another user or the like.

### Alternative Implementations

Note that the implementations described in the present disclosure are not limited to those described above, and modifications, improvements, and the like within the range in which the object of the implementations described herein can be achieved are included herein.

For example, in the above implementations, a case in which the room 20 of building 2 is rented as the rental space is exemplified, but the rental space is not limited to a conference room, a training room, and the like, and may be a tennis court, a baseball field, a stadium, a parking lot, or the like, which are outdoor spaces, or a karaoke room, a rental office, a reading space, or the like.

In the above implementations, a case where the host 1 as a management device includes the server device connected to the terminal device 3 and to the communication terminal device 23 via the Internet 5 which is the communication line is exemplified, but the management device is not limited to that including such a centralized management type server device. That is, the management device may be a distributed management type device, for example, a device using a distributed transaction ledger typified by blockchain can be used, and any device that can manage the reservation information, and send and receive various commands to and from the terminal device 3 and the communication terminal device 23 can be used. Further, in the above implementations, the host 1 as the management device and the reservation site 4 are separately provided and connected to each other via the Internet 5, but implementations described herein are not limited to this, and the host 1 and the reservation site 4 may be provided in a single site, or the function of the management device and the function of the reservation site may be implemented by a plurality of devices distributed on the Internet.

In the above implementations, the control unit 30 includes the inventory information discloser 35 that discloses the inventory information on the current goods inventory to the user when receiving the information input from the terminal device 3 of the user, but it is not necessary to disclose the goods inventory information to the user. Further, the control unit 30 includes the prediction information calculator 36 that calculates the inventory of the goods at the reservation date and time when the room 20 is used on the basis of the inventory information, and the prediction information discloser 37 that discloses the prediction information predicting the inventory to the user, but the prediction information calculator 36 and the prediction information discloser 37 may be omitted. Further, the inventory information and the prediction information may not be disclosed to the user, but may be notified only to the administrator of the rental system. Furthermore, in the above implementations, the shared goods of the shared space 25 can be used by the authentication key for unlocking the locking device 22 of the room 20, but the authentication key for unlocking the locking device 22 and the identification code for using the shared goods may be different from each other, and may be individually given to the user.

In the above implementations, as illustrated in FIG. 3, the control unit 30 causes the inventory information discloser 35 to disclose the goods inventory information obtained by the inventory information obtainer 34 (goods inventory information disclosure step: Step ST13), or as illustrated in FIG. 4, the control unit 30 causes the prediction information calculator 36 to calculate the prediction information predicting the inventory of the goods at the reservation date and time when the room 20 is used on the basis of the inventory information (inventory prediction information calculation step: Step ST31), and causes the prediction information discloser 37 to disclose the prediction information to the user (inventory prediction information disclosure step: Step ST32), but implementations described herein are not limited to this. That is, the control unit 30 may disclose the goods inventory information to the user by executing Step ST13, and may disclose the prediction information calculated by executing Steps ST31 and ST32 to the user.

Further, in the above implementations, the user who applies for the reservation from the terminal device 3 which is the user input unit may be an organizer of a lecture or a seminar, or a participant who participates in the lecture, the seminar, or the like. Further, when recruiting participants through a customer attraction site or the like for a reserved existing reservation in which the organizer (user) newly applies and the reservation information is stored in the reservation information storage 52, the control unit 30 may receive the information input from the participant (new user) who applies for participation, and update the reservation information on the basis of the information input. At this time, if the control unit can receive the amount of usage of the goods from the new user, it is possible to reduce time and effort of the organizer in reservation input.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

What is claimed is:

1. A rental space inventory management system that sets a usage time and rents a space to a user, comprising:
a management device that is connected to a communication line to manage information;
a user input means that is connected to the management device via the communication line and receives information input from the user to the management device; and
an inventory management means that is connected to the management device via the communication line and manages an inventory of goods provided to the user who uses the space, wherein
the management device comprises:
a reservation manager that manages reservation information on the user who uses the space received via the user input means, and on reservation date and time;
a goods information obtainer that obtains goods information on variation of the inventory of the goods from the inventory management means; and
a goods billing part that charges a consideration according to the variation of the inventory of the goods to the user who uses the space on the basis of the reservation information and the goods information.

2. The rental space inventory management system according to claim 1, wherein
the management device comprises:
an inventory information obtainer that obtains inventory information on a current goods inventory from the inventory management means, when receiving the information input to the management device by the user input means; and
an inventory information discloser that discloses the inventory information obtained by the inventory information obtainer to the user.

3. The rental space inventory management system according to claim 1, wherein
the management device comprises:
an inventory information obtainer that obtains inventory information on a current goods inventory from the inventory management means, when receiving the information input to the management device by the user input means;
a prediction information calculator that calculates prediction information predicting the inventory of the goods at the reservation date and time when using the space received via the user input means on the basis of the inventory information obtained by the inventory information obtainer; and
a prediction information discloser that discloses the prediction information calculated by the prediction information calculator to the user.

4. The rental space inventory management system according to claim 1, comprising
a shared inventory management means that is disposed in a shared space provided side by side with a plurality of spaces and manages an inventory of shared goods provided to the user, wherein
the management device comprises:
an identification code manager that manages identification code information related to identification codes individually set for the spaces;
a shared goods information obtainer that obtains shared goods information on the variation of the inventory of the shared goods from the shared inventory management means; and
a shared goods billing part that charges the consideration according to the variation of the inventory of the shared goods to the user who uses the space on the basis of the reservation information, the identification code information, and the shared goods information, and
the shared inventory management means switches between an available state in which the shared goods are available to the user when the identification code is received and an unavailable state in which the shared goods are unavailable to the user when the identification code is not received.
